(19) United States
(12) Patent Application Publication
(10) Pub. No.: US 2021/0049824 A1
(43) Pub. Date: Feb. 18, 2021

(54) GENERATING A MIXED REALITY

(71) Applicant: Stretfordend Limited, Wilmslow, Cheshire (GB)

(72) Inventor: Albert Edwards, Wilmslow, Cheshire (GB)

(21) Appl. No.: 17/041,715

(22) PCT Filed: Mar. 25, 2019
(86) PCT No.: PCT/GB2019/050842

§ 371 Date: Sep. 25, 2020

(30) Foreign Application Priority Data
Mar. 28, 2018 (GB) 1805022.9

(51) Int. Cl. G06T 19/00

(52) U.S. Cl. CPC G06T 19/006; H04N 13/204

(57) ABSTRACT

A method for generating a mixed reality environment, the method comprising receiving image data relating to a live event, receiving data comprising information relating to the live event, and generating a mixed reality environment based on the received image data and the data comprising information relating to the live event, wherein the mixed reality environment comprises an optical representation of the live event to be provided to a viewer and the mixed reality environment is configured such that a portion of the data comprising information relating to the live event is displayed as part of the optical representation in response to an input from the viewer.

### RELATED APPLICATIONS

The present application is a national stage application under 35 U.S.C. § 371 of International Application No. PCT/GB2019/050842, filed 25 Mar. 2019, and which claims priority from GB Patent Application No. 1805022.9, filed 28 Mar. 2018. The above-referenced applications are hereby incorporated by reference into the present application in their entirety.

### FIELD

The present disclosure relates to the field of mixed reality environments, specifically the combination of different inputs to generate a mixed reality environment.

### BACKGROUND

A virtual reality is a computer-generated simulation of a three-dimensional image or environment, be it a real-life environment or an entirely fabricated one. The virtual reality then provides a user with an immersive environment that can be interacted with in a seemingly real or physical manner.

Current virtual reality technology mainly uses virtual reality headsets that present the various images and sounds to the user in order to create a simulated world. In some examples, the user is able to look around the simulated environment and move around in it, as if in the real physical world. This produces an immersive reality that attempts to either accurately simulate a viewer's physical presence in a real-life environment or create an environment that simulates a realistic experience within a non-real-life environment or even non-realistic environment.

Virtual reality has already been developed for a variety of different uses. These include allowing individuals to experience attending a concert without being there, simulate a surgical procedure to allow a surgeon to practice, train pilots or drivers in simulated vehicles and many more such applications.

Augmented reality is the addition of computer generated or digital information with the user's real environment. The live view of the physical, real world is augmented by the digital information to create an immersive reality incorporating the additional information as seemingly tangible objects.

Augmented reality has already been used in such diverse fields as archaeology, where ancient ruins are superimposed on the current landscape, flight training, by adding flight paths to the current view, or in retail, by adding digital clothes to a video footage of one's self.

Augmented realty can be described under the umbrella term ‘mixed reality’, or ‘hybrid reality’ as it is also referred to, which is the combination of real and virtual environments. It can be used to describe the reality-virtuality continuum encompassing every reality between the real environment and the entirely virtual environment. As such, a mixed reality encompasses both augmented reality and augmented virtuality by creating environments in which physical and digital objects seemingly interact with each other and the user.

Against this evolving backdrop of new reality technology there has also been an ever-increasing desire from the public for instantly available and useable information. This information can be used for decision making or for commenting on social media or other digital platforms. A problem with the current art is that a viewer cannot easily gather the necessary information about an event in a manner that is suitable for such decision making. Another problem is that a viewer of an event, who is not at the event, can often not feel truly immersed in the event or be able to make decisions based on what is happening in the event.

The present disclosure aims to mitigate the issues discussed above.

### SUMMARY

In accordance with an aspect there is provided a method for generating a mixed reality environment, the method comprising receiving image data relating to a live event, receiving data comprising information relating to the live event, and generating a mixed reality environment based on the received image data and the data comprising information relating to the live event, wherein the mixed reality environment comprises an optical representation of the live event to be provided to a viewer, and the mixed reality environment is configured such that a portion of the data comprising information relating to the live event is displayed as part of the optical representation in response to an input from the viewer.

This aspect can provide a method for producing a mixed reality environment that combines the image data with the related information or data that the viewer can use to better understand the event or the objects or features in the live event. The viewer is able to move in, look around and experience the mixed reality environment whilst being provided with information or data that enables them to better understand the event or the objects of features in the live event. This then enables the viewer to make informed decisions, interact remotely and/or better experience a truly immersive world.

Optionally, the process of generating the mixed reality environment comprises generating a first mixed reality environment based on the received image data for providing the optical representation and generating a second mixed reality environment based on the first mixed reality environment and the data comprising information relating to the live event.

Optionally, the process of receiving the image data also comprises capturing the image data. The capturing of the image data means that a provider of the visual data can ensure that the desired view or views of the live event are captured so that the subsequently generated mixed reality environment provided to the viewer will include the optical representation that is most desired by the viewer or useful to them. Similarly, the optical representation may be that which is most desired by the provider of the visual data.

The capturing of the image data may comprise capturing a panoramic stereoscopic view from at least one camera array at a respective capture location. The optical representation may be generated by remapping the image data into a stereoscopic panorama. The stereoscopic method creates the illusion of three-dimensional depth from given two-dimensional images.

The image data may comprise a plurality of views of the live event. The plurality of views means that the subsequently generated new reality environment provided to the viewer will be fully immersive and realistic.

Optionally, the method may further comprise receiving audio, measurement and/or telemetry data relating to the live event. The measurement and/or telemetry data can be used to generate the mixed reality environment.

Optionally, the image data may be video data. The video data can be used to create a realistic mixed reality environment that changes in real time with the minimum amount of digital processing. For example, the video data may be a broadcast of a live event that enables the viewer to experience the live event whilst providing them with the information about what is happening in the live event.

Optionally, the information relating to the live event may be at least one of: information about the event; information about objects, entities or other features featuring in the event; and information about incidents occurring in or arising from the event. This means the viewer is provided with all the information they need in order to fully experience the mixed reality environment and make informed decisions within the mixed reality environment or outside the mixed reality environment, and/or interact within or outside the mixed reality environment.

Optionally, the portion of the data may be defined by requirements of at least one of: the viewer of the image data; a provider of the image data; a rights holder of the image data; and a provider of the mixed reality environment service. For example, in the case of a sporting event such as a football match, the provider of the image data may be the authorised broadcaster of the match; subcontractors filming the football match; the league or organisation in charge of the match; the football clubs participating; or another provider. They may each have separate requirements depending on subscriptions or tickets paid for by the viewer, legal or technical requirements, pressures placed on them by advertisers or other third parties, or the desire to ensure that the best optical representation is presented to the viewer.

Optionally, the information relating to the live event may be updated in real time. This means the viewer is presented with the most up-to-date information and so can best make informed decisions in real time.

Optionally, the optical representation may be a view of the live event from a determined position in the mixed reality environment. The determined position may be determined based on an input from at least one of: the viewer of the image data; the provider of the image data; the rights holder in the image data; and the provider of the new reality environment service. This means the optical representation that the viewer is presented with can be chosen based on subscriptions or tickets paid for by the viewer, legal or technical requirements, pressures placed on them by advertisers or other third parties, a desire to ensure that the best optical representation is presented to the viewer, or the preference of the viewer etc.

Optionally, the view of the live event may be a field-of-view view of the live event. This means that the experience of the mixed reality environment will more accurately simulate the view the viewer would have in a real environment, making the experience more realistic and immersive.

The mixed reality environment may be generated based on at least one of: third-party data, GPS, environment mapping systems, geospatial mapping systems, triangulation systems; and/or viewer inputs. This enables the live event to be as accurately portrayed as possible

Optionally, generating the mixed reality environment may comprise receiving and/or generating further data and rendering the further data as articles in and/or around the optical representation. The further data may be advertising, social media input or further information the viewer may be interested in that is not related to the live event.

The articles may be components of the optical representation and/or superimposed over the optical representation and/or form a head-up display. The articles may be within the mixed reality environment, forming physical articles that can be interacted with by being picked up etc. Alternatively, or in addition, the articles may be digital representations that form a head-up display that are stationary regardless of the movement of the viewer or change in view.

Optionally, the data comprising information relating to the live event may be embedded into the first mixed reality environment in relation to at least one object in the environment to generate the second mixed reality environment. The information may relate to the particular object, describing it or its interaction with other objects in the event. The information may be overlaid on the object, positioned as a tag or embedded as information related to the object that is only visible when the objected is interacted with.

Optionally, the object may be a human and facial recognition may be used to attach the data to particular entities in the optical representation. In the case of a live event that involves people, for example a football match, the objects may be the humans in the live event. Facial recognition allows the relevant information to be embedded in the new reality environment in relation to the correct human.

The image data and the data comprising information relating to the live event may be processed with a timecode at the point of creation and displaying the portion of the data may be based on the timecode. This allows the correct information to be overlaid at the correct time and/or for the correct object.

The data may be accessed when the input from the viewer interacts with the object.

This means that the viewer can enjoy the optical representation, uncluttered by information, until they want to know more information about an object. At this point they can interact with the object and be presented with the relevant information.

The input from the viewer may comprise interactions within the mixed reality environment. The information about the event may then only appear in the optical representation when desired, either consciously or subconsciously, by the viewer through their active interactions within the mixed reality environment.

The interactions may be in real-time in order to give the viewer a fully immersive and realistic experience. The real-time nature of the mixed reality environment means that any interaction with third parties or social media etc. can be at the same time as the occurrences in the event.

Optionally, the interaction may comprise at least one of geospatial body movement of the viewer, hardware orientation and oral input. Preferably, the hardware orientation tracking may comprise linking a view of the viewer to the orientation of the hardware and the centre of the viewer's view is used to define the viewer interest. This means the viewer can look around the mixed reality and their view or interest can be used to define an interaction.

Optionally, a viewer interest may be registered as an interaction when the centre of the viewer's view is stationary on a particular object or icon for a fixed period of time

By merely focussing in on an object for a specific length of time the desired information about the object may be displayed to the viewer. This means that the input can take into account the subconscious interactions and so interests of the viewer. This is especially useful in providing the viewer with an environment that can essentially predict their desires or want for specific information. This may be used for targeted advertising for instance.

Optionally, the method may further comprise storing each interaction. The stored interaction may be fed back to any combination of: the viewer of the image data; the provider of the image data; the rights holder in the image data; the provider of the mixed reality environment service; the provider of the data comprising information relating to the event; or a third-party. The information can be used to improve the service, provide targeted advertising to the viewer or be used by third parties to change their respective services in light of the information contained in the stored interaction data.

Optionally, displaying the portion of data may comprise animating, transforming or adapting the portion of data in response to the interaction. This may put the portion of data into a more presentable, exciting or user-friendly format.

Optionally, the interaction may be used to connect to and/or control third-party content. The third-party content may be any of: applications, equipment, vehicles, autonomous control systems, automated and/or any HCl driven systems or any other content. The third-party content may be within the mixed reality environment and be controlled within the environment. For example, this may be a vehicle that may be driven around the environment, taking into account the physical boundaries of the objects within the environment. The third-party content may, for example, be an application or program that is run within the environment when interacted with. The third-party content may comprise at least one of: online stores, social media platforms, betting sites or other websites, databases or online content. This may enable the viewer in light of the information they have been presented with in the new reality environment to post statuses or comments on social media, buy products from online stores or make a bet on an online betting site.

According to a second aspect of the disclosure, there is provided a system for generating a new reality environment, the system comprising a processor configured to perform the method of any preceding claim and a display module configured to display the optical representation.

This aspect can provide a system for producing a mixed reality environment that combines the image data with the related information or data that the viewer can use to better understand the event or the objects or features in the event. The viewer is able to move in, look around and experience the mixed reality environment whilst being provided with information or data that enables them to better understand the event or the objects of features in the event. This then enables the viewer to make informed decisions, interact remotely and/or better experience a truly immersive world.

Optionally, the system also comprises at least one camera array configured to capture the image data relating to a live event.

The capturing of the image data by the camera array means that a provider of the visual data can ensure that the desired view or views of the live event are captured so that the subsequently generated mixed reality environment provided to the viewer will include the optical representation that is most desired by the viewer or useful to them. Similarly, the optical representation may be that which is most desired by the provider of the visual data. The camera array itself can be chosen to capture the visual data in a format or way that is preferred by the provider of the visual data.

Preferably the display module is at least one of: an enabled games console, a games console, a mixed reality headset, a mixed reality enabled phone, a movement sensor enabled smart phone, a smart phone, a 3D enabled TV, a CCTV system, a wireless video system, a smart TV, smart glasses, shuttered 3D glasses, a computer.

In some preferred embodiments, the system also comprises hardware to be used by the viewer and the processor is configured to register inputs from the hardware as interactions from the viewer. Optionally, the registering of the inputs from the hardware uses at least one of geospatial body tracking of the viewer, hardware orientation tracking or a physical input. Preferably, the hardware comprises at least one of: controllers, cameras, wands, microphones, movement sensors, accelerometers, hardware tracking devices, hardware orientation tracking devices, body tracking devices, keypads, keyboards, geospatial tracking devices, internet activity detecting devices, mice, in order to register the viewer interactions and/or inputs.

This provides the viewer with hardware they are familiar with to be able to use the system easily. The interactions registered from the hardware create the interactive environment, displaying the desired information at the command of the viewer.

According to a third aspect of the disclosure, there is provided a computer program residing on a non-transitory processor-readable medium and comprising processor-readable instructions configured to cause a processor to perform the method.

### BRIEF DESCRIPTION OF THE DRAWINGS

Exemplary arrangements of the disclosure shall now be described with reference to the drawings in which:

FIG. 1 shows a system for generating a mixed reality environment;

FIG. 2 shows the capture side sub-system of the system shown in FIG. 1;

FIG. 3 shows the management side sub-system of the system shown in FIG. 1;

FIG. 4 shows the client-side sub-system of the system shown in FIG. 1;

FIG. 5 shows an exploded view of part of a camera array;

FIG. 6 shows an assembled camera array;

FIG. 7 shows a capture sub-system capturing a live event;

FIG. 8 shows a viewer's view of a first mixed reality environment

FIG. 9 shows a view of the live event from a stereoscopic camera pair;

FIG. 10 shows a virtual viewing room;

FIG. 11 shows a viewer using the disclosed second mixed reality environment;

FIG. 12 shows a viewer interaction in the second mixed reality environment;

FIG. 13 shows a method according to the disclosure;

FIG. 14 shows a block diagram of a computing device configured to perform any method of the disclosure.

Throughout the description and the drawings, like reference numerals refer to like parts.

### SPECIFIC DESCRIPTION

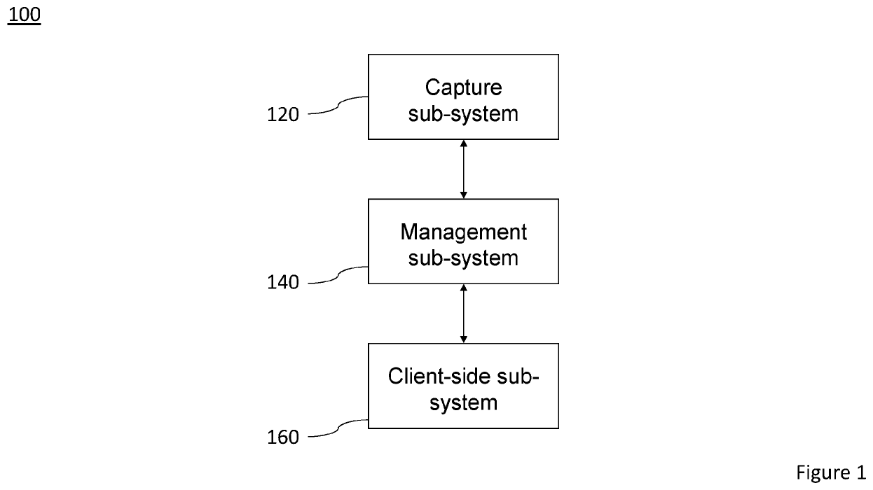

Referring to FIG. 1, there is shown an overview of a mixed reality generating system 100 according to a preferred embodiment. The mixed reality generating system 100 comprises a capture sub-system 120 configured to receive or capture image data relating to a live event, a management sub-system 140 configured to receive the image data from the capture sub-system and data comprising information relating to the live event and combine the two sets of data, and a client-side sub-system 160 configured to receive the combined data and generate and display a mixed reality environment.

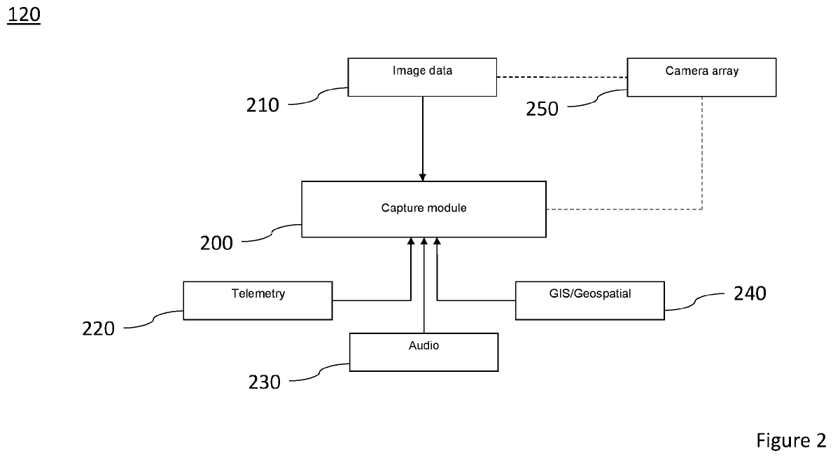

Referring to FIG. 2, the capture sub-system 120 of the mixed reality generating system 100 is shown in more detail. The capture sub-system 120 comprises a capture module 200 configured to receive image data 210 relating to a live event. The image data 210 may be images or video in any suitable format. In a preferred embodiment, the image data 210 is video data. The format may be JPEG, TIFF, GIF, HDR or any other format known in the art. The video may be a digital video stream or a digitisation of an analogue video stream in any suitable format, such as MPEG, MPEG-4, Audio Video Interleave, CCTV Video File, High Definition Video or other suitable formats. In some embodiments, the image data 210 are the images or video of a live event. This may be a live broadcast or recording of a sporting event, a concert, a manufacturing process or production line, surgical procedure or any other event. The image data 210 may also be images or video of a live event defined as the views from a cameras or sensors on a drone, satellite, submersible vehicle, aeronautical system, car or any other vehicle, be it autonomous, controlled remotely or controlled in person. In some embodiments, the image data is a stereoscopic panoramic view of the live event, as explained in more detail below, although any type of view may be received and used. Furthermore, any combination of different types of image data 210, such as images and video, or videos of different formats, may also be received and used.

Video data can be used to create a realistic mixed reality environment that changes in real time with the minimum amount of digital processing. For example, the video data may be a broadcast of a live event that enables the viewer to experience the live event whilst providing them with the information about what is happening in the live event.

The image data 210 may be received from a broadcaster, an owner of the image data, an entity running the live event or another entity. For example, in the case of a sporting event such as a football match, the image data 210 may be received from the authorised broadcaster of the match; the subcontractors filming the football match; the league or organisation in charge of the match; the football clubs participating; or another provider. In the case of a concert, the image data 210 may be received from the subcontractors filming the concert or the management team running the concert, or another provider. In the case of a manufacturing process such as a production line, the image data 210 may be received from CCTV footage of the process or other series of cameras recording the live event. In the case of a surgical procedure it may be image data 210 received from an endoscope camera or other internal camera or any external camera system. In the case of a drone or other vehicle the image data 210 may be received from an on-board camera system.

Capture module 200 is further configured to receive other data such as telemetry 220, audio 230, geospatial 240 or any other available location specific data. This data may be received with the image data 210, be it embedded in the image data 210, attached to the image data 210 or combined in any other way, or it may be received separately to the image data 210. This data may be received from third parties or the same parties as the providers of the image data 210.

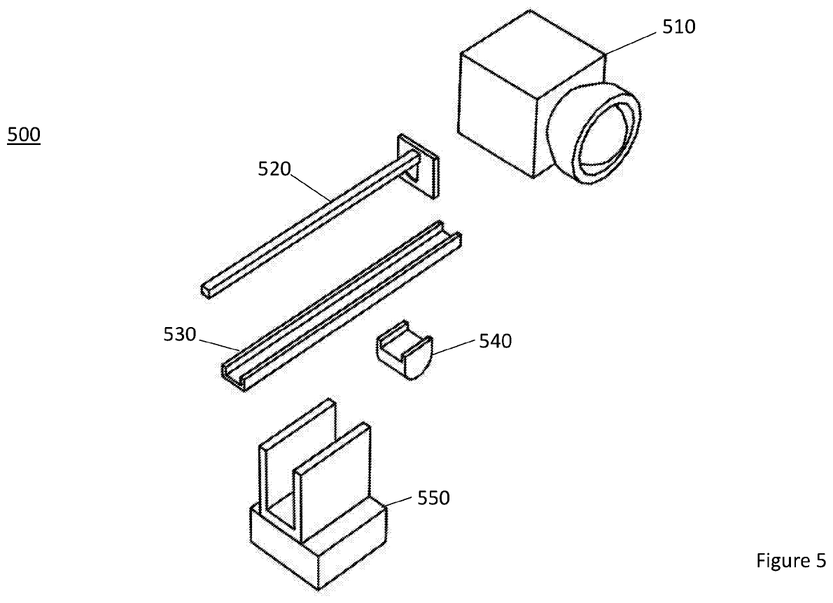

The image data 210 relating to a live event may optionally be captured using a camera array 250 that may be controlled by the capture module 200. The camera array 250 may be a plurality of camera arrays. This is disclosed in more detail in relation to FIGS. 5 to 7.

The capturing of the image data means that a provider of the visual data can ensure that the desired view or views of the live event are captured so that the subsequently generated mixed reality environment provided to the viewer will include an optical representation of the live event that is most desired by the viewer or useful to them. Similarly, the optical representation may be that which is most desired by the provider of the visual data.

Optionally, the capture module 200 is also configured to capture any of the telemetry 220, audio 230 and GIS/geospatial 240 data related to the live event.

Capture module 200 is further configured to combine any data it has received and/or captured and send the combined data to the management sub-system 140 in real time. The capture module 200 may comprise a processor and memory storage component. The memory storage component is configured to store data that the capture module 200 has received and/or captured. The processor is configured to combine the data. The data can be combined in any manner. The data may be combined into a single packet of data, with the two pieces of data remaining distinct, or may be merged into a single format.

The capture module 200 may be configured to send the combined data to the management sub-system 140 via any combination of IP, 4G, closed digital systems, radio communication, wired connection, Bluetooth, NFC, RFID, ANT, WiFi, ZigBee, Z-Wave or any other protocol or method that supports real-time communication and data transfer.

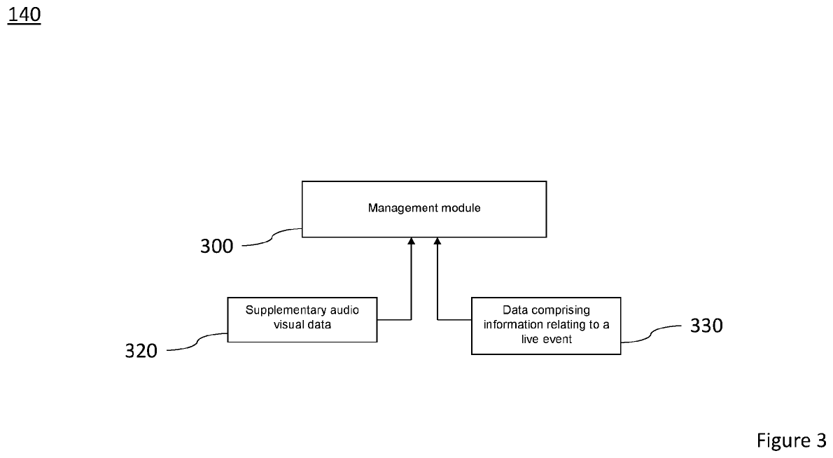

Referring to FIG. 3, there is shown an overview of the management sub-system 140 of the reality system 100. The management sub-system 140 comprises a management module 300 configured to receive the combined data from the capture module 200. The management module 300 may also be configured to receive supplementary audio-visual data 320 and data comprising information relating to the live event 330.

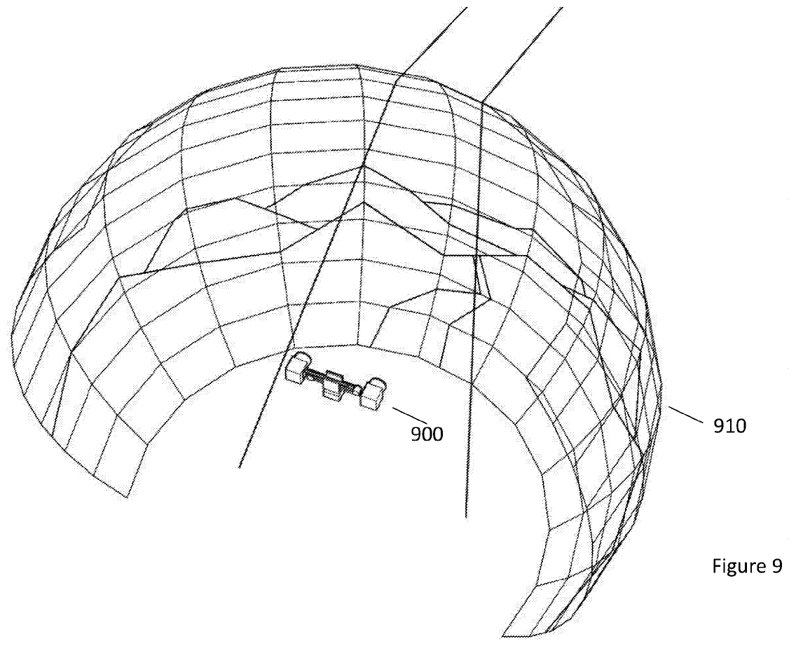

The supplementary audio-visual data 320 is extra audio or visual data of the live event or related to the live event. This data may be received from the same sources as provided the image data 210, the telemetry 220, audio 230, or geospatial 240 data, or may be from a different entity. The supplementary audio-visual data 320 may also be computer-generated data that can be used to augment the image data 210 during the process of generating the mixed reality environment during the client-side stage of the process, as will be disclosed in more detail in relation to FIG. 9.

The data comprising information relating to the live event 330 is data comprising any combination of: information about the event; information about objects, entities or other features featuring in the event; and information about incidents occurring in or arising from the event. The data is not derived from the image data 210 itself, although it may be from the same source, or a different source. The data comprising information relating to the live event 330 is updated in real time as the information about the event itself changes or is updated. The data comprising information relating to the live event 330 may be supplied by a third-party.

In the example of a football match, the data comprising information relating to the live event 330 may be information about the match including, but not limited to, information about the teams playing, the competition the teams are playing in, the time of kick off, the location of the match etc. The information 330 may be information about objects, entities or other features in the match, including, but not limited to, each player's biography, social media information, league/competition statistics, match statistics, betting odds, recent news, injury record, and any other information about the player. The information 330 may be about teams in the match, including their history in the league/competition, current form, squad, injuries, recent news, league position, social media and website information, and any other information relating to the teams.

The information 330 may be about incidents occurring in or arising from the match. This may be, but is not limited to, information about the effect of a particular event (for example a goal) on the betting odds or league position, information about the match statistics, number of substitutions, commentator or social media opinion, injury updates, player ratings, predictions or any other information occurring in or arising from the match.

Similarly, the information 330 may comprise information about the managers, the crowd, the stadium itself, the commentators, advertisers, broadcasters or any other information that arises from the match.

In the example of a manufacturing process, the data comprising information relating to the live event 330 may be information about the process, including, but not limited to, the various steps in the process, the length of the process and its steps, the materials and/or chemicals required and their amounts or any other information about the process. The information may be about the objects, entities or other features in the process. This may include, but is not limited to, information about the various machines, reactions, stages, materials, or any other feature in the process; information about suppliers, shops, stores or online retailers that sell the various objects, entities or features and information about delivery times, costs etc; information about stock levels, distribution channels, timings of deliveries, speed or rate of the process etc. The information may be about the incidents occurring in or arising from the process, including, but not limited to, probabilities of risks or failures and information about how to correct them, information about speeding up or changing certain parts of the process, warning about supply levels or physical properties such as pressure, temperature, humidity, pH etc.

Management module 300 may also be configured to receive extra data comprising for example, advertising information, social media information, or other third-party information. Such information would not be related directly to the event but may be indirectly related. For example, in the case of a football match the advertising may be related to football, if not that direct match, or the social media information may be related to sport in general etc.

Management module 300 is configured to combine the data it receives into client-side input data. The management module 300 may comprise a processor and memory storage component. The memory storage component is configured to store data that the management module 300 has received and/or captured. The processor is configured to combine the data. The data can be combined in any manner. The data may be combined into a single packet of data, with the two pieces of data remaining distinct, or may be merged into a single format. What data it receives or what data it combines or sends on to the client-side subsystem 160 may be related to stored profile information about the viewer or client. This stored profile information may be stored in the management module 300 or may be stored in another part of the mixed reality generating system 100 and passed onto the management module 300. This stored profile information may be specific requests or subscription data either from the viewer themselves or from the provider of any of the data, owner or rights holder of the image data, provider of the mixed reality environment service or other party.

The management module 300 is configured to send the client-side input data to the client-side subsystem 160 via any combination of IP, 4G, closed digital systems, radio communication, wired connection, Bluetooth, NFC, RFID, ANT, WiFi, ZigBee, Z-Wave or any other protocol or method that supports real-time communication and data transfer.

In the case of certain applications, for example military of medical applications, a direct capture to client process may be provided. This would require all the data to be sent directly to the client-side subsystem 160, rather than go through or be received by the management subsystem 140. In this instance, the tasks of the management subsystem 140 may be performed by the client-side subsystem 160. This would mean that the data and information is more secure.

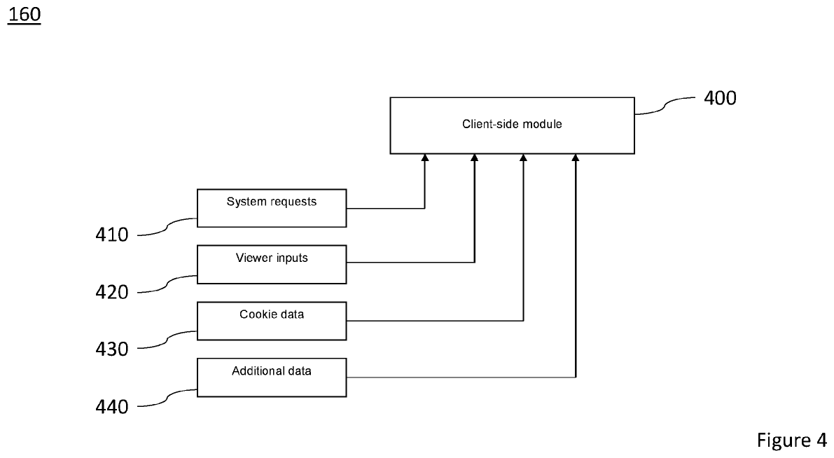

Referring to FIG. 4, there is shown an overview of the client-side sub-system 160. Client-side sub-system 160 comprises a client-side module 400 configured to receive the client-side input data, i.e. the data that was combined at management side sub-system 140, system requests 410, client inputs 420, cookies 430 and additional data 440.

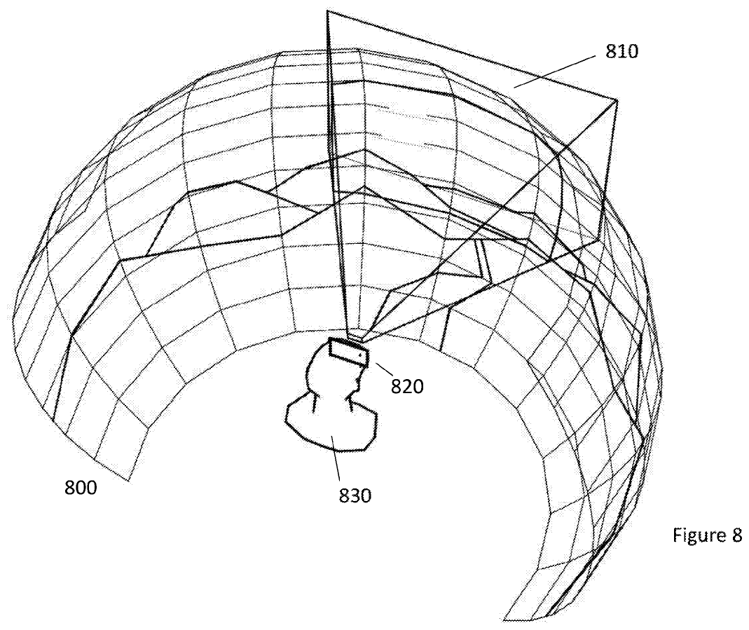

Client-side module 400 is configured to map the client-side input data and/or also the additional data 440 into mixed reality environment. Client-side module 400 generates a mixed reality environment based on the image data 210 and the mixed reality environment based on the mixed reality environment and the data comprising information relating to the live event 330. The generation of the environments is described in more detail in relation to FIGS. 8 to 10.

The client-side subsystem 160 may also be configured to send information to the management side module 300 about any viewer interactions. The client-side subsystem 160 may store the interactions and/or send them on to an external interaction database. A portion of the interactions can then be sent to the viewer themselves or to the provider of any of the data, owner or rights holder of the image data, provider of the mixed reality environment service or any other party. This may also include third parties that request the interaction data. These third parties may include media companies, social media companies, government organisations, charities, marketing companies, advertising companies or any other third-party.

Referring to FIG. 5, there is shown an exploded view of part of a camera array 500 according to a preferred embodiment. The camera array 500 may be used as the camera array 250 referred to in relation to FIG. 2. The camera array 250 is deployed at the scene of the live event.

The camera array 500 comprises a camera 510. In a particular embodiment, the camera 510 is equipped with a fisheye lens although it will be envisaged that other suitable alternative lenses may be used. The camera array 500 further comprises an articulated camera arm 520 that sits within a rack 530 that is powered by a motor 540. The motor 540 is controlled by hardware 550 that also controls the camera 510 and is itself controlled by the capture module 200. The articulated arm 520 is able to move along the rack 530, allowing the horizontal movement of the camera 510. The camera can be axially, radially or cylindrically mounted and can be fixed in any of those directions. It can be articulated with controls from the hardware 550 which can control all aspects of the camera including, but not limited to, the camera's placement, orientation, configuration and focus ranges.

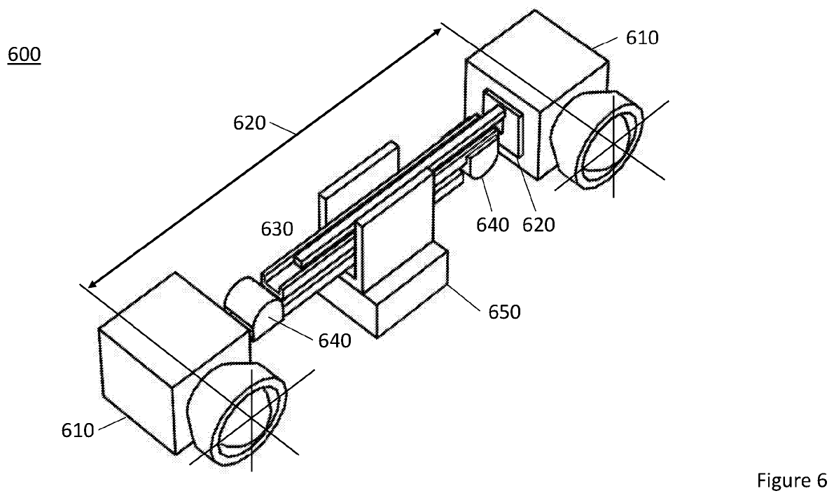

Referring to FIG. 6, there is shown an assembled camera array 600 in a paired array configuration. The camera array 600 may be used as the camera array 250 referred to in relation to FIG. 2. The camera array 250 is deployed at the scene of the live event. This paired array configuration uses two cameras 610, though it will be envisaged that any suitable number of cameras may be used. Each camera 610 in the camera array 600 comprises an articulated camera arm 620 that sits within a rack 630 that is powered by a motor 640 controlled by the hardware 650 that is itself controlled by the capture side module 200, similar to the camera array 500 described in relation to FIG. 5. As explained above, each articulated arm 620 is able to move along its respective rack 630, allowing the horizontal movement of each camera 610. This provides for inter-camera distance extension or contraction which allows for the control of pupillary distance.

In a preferred embodiment, the camera array 600 is made up of two cameras 610 as a stereoscopic pair. Each camera 610 in the pair is configured to capture exclusively video for the left and right eyes respectively (which can be referred to as ‘per-eye’ capture). This means that when they are combined at the client-side stage of the process, the illusion of depth is created, and a 3D representation may be presented to the viewer. Stereoscopic capture is well known in the art, including its requirements for buffers, processors, short term memory etc. It is possible to use various camera array configurations, types and recording methods; the method is not restricted to the stereoscopic method.

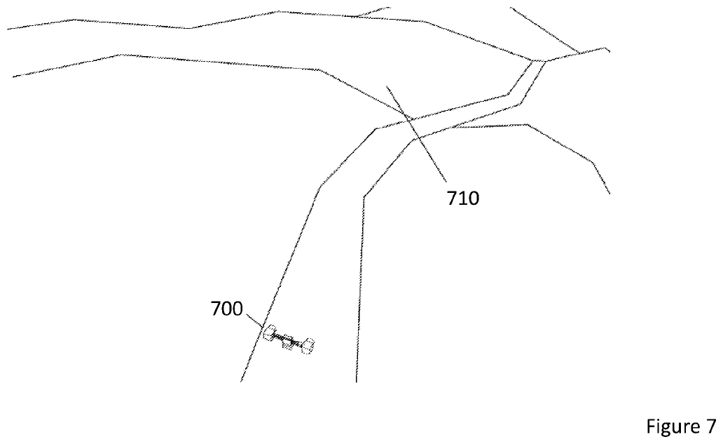

Referring to FIG. 7, there is shown a camera array 700 capturing a live event 710. Although the live event 710 in this case is a landscape, the live event 710 may be any of the events mentioned above. The camera array 700 may the camera array 250 described in relation to FIG. 2, camera array 500 described in relation to FIG. 5 or camera array 600 described in relation to FIG. 6. The camera array 700 is able to rotate and/or move around the environment, capturing images or video as it does so. It collates the image or video into image data 210. The camera array 700 may also be stationary, with individual cameras rotating. Although one camera array 700 is shown, any number of camera arrays 700 could be used. The multiple camera arrays 700 may be moving around in and/or positioned in a fixed position in or around the live event 710, capturing different views of the live event 710. The greater the number of camera arrays 700 used, the greater the level of coverage of the live event 710. Preferably, a number of camera arrays 700 and/or cameras is used that results in the entirety of the live event 710 being captured/recorded.

The camera array 700 and/or individual cameras 510, 610 can be fixed or static and any of automated; human controlled, be it present or remotely; Al controlled, or any other form of control.

Referring to FIGS. 8 and 9, the generation of a first mixed reality environment 800 is shown. Client-side module 400 is configured to generate the first mixed reality environment 800, by defining a viewer coordinate system based on a viewer 830 and the received image data 210. The process of generating the first mixed reality environment 800 is known in the art. In brief, a viewer coordinate system is extrapolated from the image data 210, telemetry data 220 and GIS/geospatial data 240, any parabolic distortion and the scale of the world in relation to the recording. The telemetry data 220 may include the inter-pupillary distance of the recording equipment, which may be the inter-lens distances of the cameras 510, 610 in the camera array 250, 500, 600, 700. The telemetry data 220 may also include any other measurement data that would be useful in creating a viewer coordinate system in order to generate a mixed reality environment. The geospatial data 240 may be the geographic position of the recording.

The viewer coordinate system further uses any geometric triangulation of the image data 210, telemetry data 220, geospatial data 240 or other data. For example, the data may consist of known dimensions, angles or distances at capture. This may comprise relative camera distances, camera inter-lens distances, passive or active geospatial tagging, GPS distances, post capture or at the point of capture automated or manual tagging of features of known dimension, post capture automated or manual tagging of features of unknown dimension against known dimension, post capture approximation of dimensions through multiple viewpoint tagging, or any other measurement data. The triangulation can be repeated throughout the generation of the mixed reality environment to ensure that the environment is as accurate as possible.

Once the viewer coordinate system has been generated, the client-side module 400 can accurately map the various sources of image data 210 onto the viewer coordinate system, i.e. the various different images or videos from the cameras 510 in the camera arrays 250. The viewer coordinate system ensures that all the received data has a single shared origin that they can be placed around. The viewer coordinate system also ensures that the received data can be overlapped, combined or in any way visually matched regardless of visual distortions.

In the case of multiple camera arrays, the image data 210 from each camera 510, 610 of a camera array 250, 500, 600, 700 will show a different view of the live event 710. In the case of a stereoscopic camera pair, such as camera array 900 in FIG. 9, each camera in the pair is configured to capture exclusively image data for the left and right eyes respectively. The camera array 900 may be the camera array 700 described in relation to FIG. 7. This means that the two views may be combined to create a new view 910 of the live event 710 that has the illusion of depth. The stereoscopic camera pair 900 may capture video of the live event 710, with each camera in the pair configured to capture exclusively video for the left and right eyes respectively. The videos represent different views of the live event 710 that may be combined to create a new view 910 of the live event 710 that has the illusion of depth.

Each view of the live event 710, be it from combined data from a stereoscopic camera pair, or different views from image data 210 from different cameras that are not part of stereoscopic camera pairs, is mapped onto the viewer coordinate system, to create a 360° panoramic view of a mixed reality environment 800. In the case of video input, the video data from each camera 510, 610 of a camera array 250, 500, 600, 700, 900 is mapped onto the viewer coordinate system to create a 360° panoramic video or a mixed reality environment 800. Multiple views from multiple camera arrays 250, 500, 600, 700 or the same camera array may be mapped onto the viewer coordinate system in order to create the first mixed reality environment 800. The mapping onto the viewer coordinate system may involve overlaying image data from one camera 510, 610 over image data from another camera 510, 610, be it from the same camera array 250, 500, 600, 700, 900 or a different camera array 250, 500, 600, 700, 900.

Optionally, at this stage augmentation may occur in order to ensure that the first mixed reality environment 800 is as accurate as possible. This may be, for example, generating computer imagery to enhance the captured landscape or complete any missing features, sections or objects etc. The computer-generated imagery is mapped onto the viewer coordinate system.

Optionally, GPS, Galileo, Beidou, GLONASS or any available location mapping service may be used to match the generated location of first mixed reality environment 800 to the real-life location of live event 710.

The resulting mapping (or overlay) is rendered in order to generate the first mixed reality environment 800 that can be displayed to the viewer as an optical representation 810 of the live event 710. The use of multiple image sources means that the world can feel truly immersive and complete from any angle or view.

The resulting mapping (or overlay), in the case of a stereoscopic system, may be rendered out per-eye in order to generate the first mixed reality environment 800 that can be displayed to the viewer as an optical representation 810 of the live event 710. In the case of a stereoscopic system, the viewer would have left and right eye image data displayed to him that create the illusion of depth. The left and right eye image data will change according to the view the viewer has chosen within the mixed reality environment. The computer-generated imagery would be rendered out for each of the left and right eye and overlaid over the respective left and right eye image data that would be displayed to the viewer. This means the computer-generated imagery should match up in the first mixed reality environment 800 regardless of visual distortions or differing lens focal lengths etc.

In the case of a single stereoscopic camera array 600, the viewer coordinate system is generated as explained above and the augmentation may occur to add computer-generated imagery. The imagery is then rendered out per eye and overlaid over the corresponding image data channels (a left render for the left eye image data and a right render for right eye image data). This means the computer-generated imagery should match up in the first mixed reality environment 800 regardless of visual distortions or differing lens focal lengths etc.

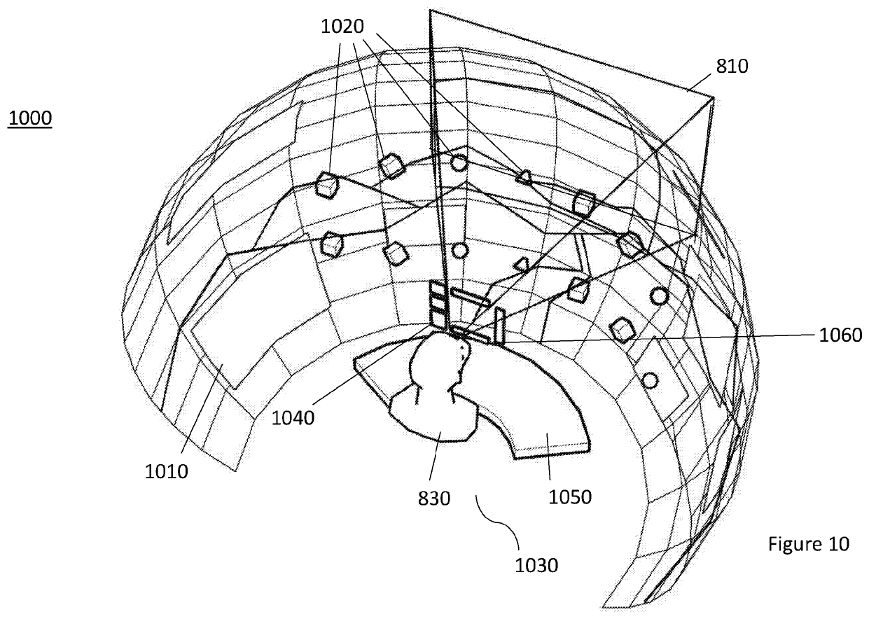

Referring to FIG. 10, the viewer coordinate system also ensures that the data comprising information relating to the live event 330, any additional data 440 and any other information can be positioned accurately in the first mixed reality environment 800 in order to generate a second mixed reality environment 1000. This means they can be positioned to exactly match the live event 710 or correspond to the objects, entities or other features featuring in the live event 710. The various pieces of data that make up the data comprising information relating to a live event 330 or the additional data 440 do not have to be displayed in the second mixed reality environment 1000 at all times. They can be embedded behind the displayed mixed reality by being linked to a particular object, entity or other feature. In this way they are attached to specific coordinates so that they appear in the right place when an input indicates they should be displayed as part of the optical representation. The right place doesn't have to be superimposed on the related/linked object, entity or other feature, but may be near to the feature, for example 1010 in FIG. 10, or anywhere in the second mixed reality environment 1000. Furthermore, the position of the displayed data comprising information related to the live event 330 may be chosen by the viewer 830 and may vary according to which object, entity or feature is chosen.

In the case of human entities, facial recognition may be used to attach the correct data comprising information related to the live event 330 to the correct human. For example, in the case of a football match, the biography of a particular player may be attached to the correct player using facial recognition that would recognise who the player is.

Furthermore, articles 1020 may be generated based on the additional data 440 and may for example comprise advertising which may take the form of 3D computer generated objects depicting what is being advertised.

Client-side module 400 is further configured to render the second mixed reality environment 1000, in a similar process to that described above. The video footage or image data rate will determine the overall frames-per-second (master frame rate) of the generation and subsequent display of the second mixed reality environment 1000. The image data 210, data comprising information relating to the live event 330, any additional data 440 and any articles 1020 generated using said data is rendered in the viewer coordinate system according to timecode and updated at the master frame rate. All data is processed with a timecode at source or point of generation. This timecode ensures that timing discrepancies can be minimised, leading to a seamless and smooth generation and display of the second mixed reality environment 1000. The timecode also ensures that the correct information can be overlaid at the correct time and/or for the correct object.

In some embodiments, the mapping may be performed at the management side module 300 and the resulting data sent to the client-side module 200 for rendering.

The system described above is configured to generate a first mixed reality environment 800 based on the received image data 210 for providing the optical representation 810 and then generate a second mixed reality environment 1000 based on the first mixed reality environment 800 and the data comprising information relating to the live event 330. Alternatively, the process of generating the first and second mixed reality environments could be merged into a single step of producing a mixed reality environment based on the received image data 210 and the data comprising information relating to a live event 330.

The portion of the second mixed reality environment 1000 that is displayed as an optical representation 810 to the viewer 830 will ultimately depend on the hardware being used by the client-side sub-system 120. The hardware may include, but is not limited to, an enabled games console, a games console, a mixed reality headset, a mixed reality enabled phone, a movement sensor enabled smart phone, a smart phone, a 3D enabled TV, a CCTV system, a wireless video system, a smart TV, smart glasses, shuttered 3D glasses, and/or a computer.

The size of available display will dictate the portion of the second mixed reality environment 1000 that will be displayed, the portion dictating the viewer's field of view. As the viewer 830 turns or moves his hardware, the client-side module 400 will track their movement and the field of view will move around the second mixed reality environment 1000, changing the optical representation 810 that is displayed to the viewer 830. Essentially, the viewer 830 can look around the second mixed reality environment 1000 as if they were there, with their vision mimicking the field of view that a person has in reality. As such, although dependent on the hardware used, the field of view will preferably be limited to around 135°. This means that the experience of the second mixed reality environment 1000 will more accurately simulate the view the viewer 830 would have in a real environment, making the experience more realistic and immersive.

Optionally, as shown in FIG. 10, a viewer virtual room 1030 may be generated. Around the foreground of the viewer's view, additional data 440 can be used to generate articles that can form a Head Up Display (HUD) 1040. This HUD 1040 can be superimposed over the optical representation 810 or can frame the optical representation 810 as shown by 1060 in FIG. 10. The viewer virtual room may also comprise additional computer-generated structures 1050. For example, in the case of the system being used for surgery, wherein control of surgical instruments is facilitated, as explained below in the explanation of the interactions, computer-generated structure 1050 may be a table that holds the surgical equipment the viewer may use during the surgery. The viewer may lift the equipment off the table which may act as an input to facilitate control of the third-party equipment in the real world, as displayed in second mixed reality environment 1000.

The virtual room 1030 can be rendered in the viewer coordinate system and updated at the master frame rate. The virtual room can be customizable by the viewer 830 or provider of the system.

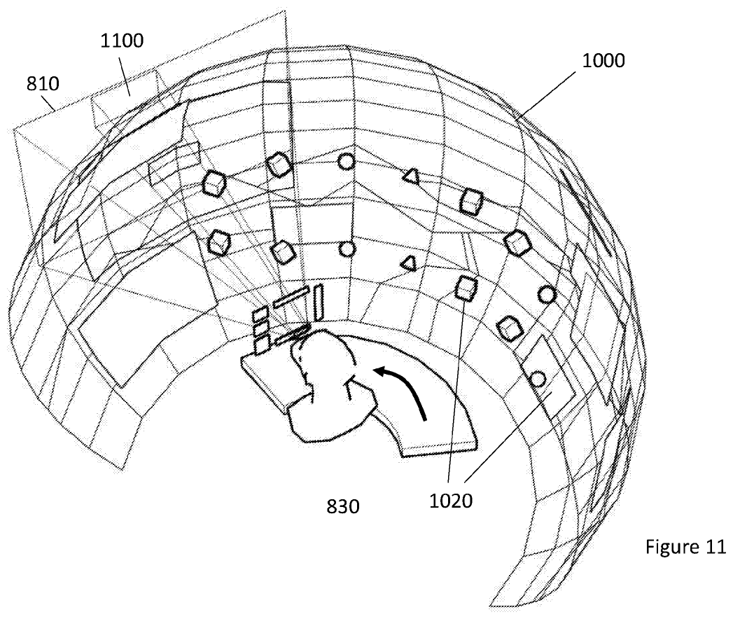

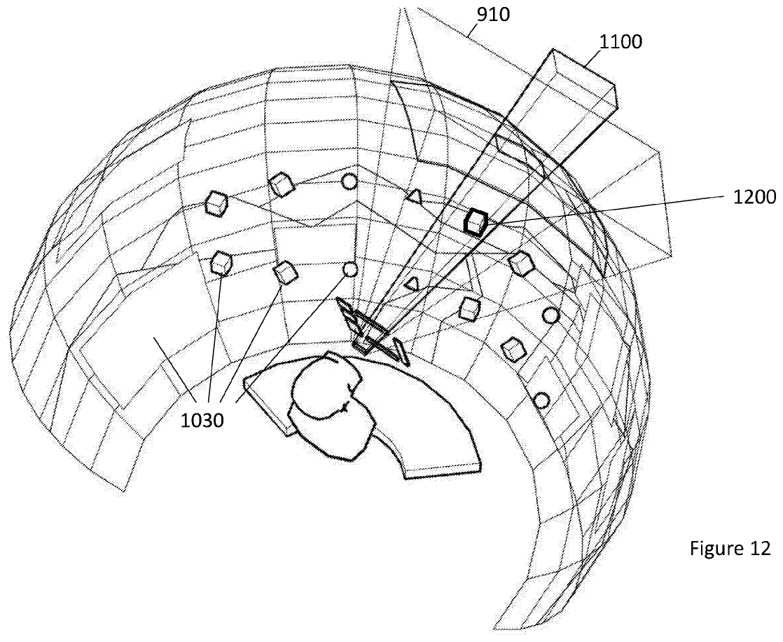

Referring to FIGS. 11 and 12, the display of a portion of the data comprising information relating to the live event 330 as a result of an input 420 from the viewer 930 in a preferred embodiment is shown. The input 420 can be in real time, and the display of the information is also in real time. When combined with the fact that the data comprising information relating to the live event 330 is updated in real time as well, this means the viewer 830 is presented with the most up-to-date information and so can best make informed decisions in real time using the information. The real-time nature of the second mixed reality environment 1000 also means that any interaction with third parties or social media etc. can be at the same time as the occurrences in the event.

The input 420 may be any physical input, oral input, tracking of physical movement of a device, tracking of physical movement of a viewer, or any other input. For instance, the input 420 may be physical inputs from a controller, keypad, keyboard, mouse, touchpad, scroller, or any other device. The input 420 may be an oral input into a microphone, sensor or any other device that monitors sound. The input 420 may be tracking the physical movement of a device, including, but not limited to, an accelerometer, hardware tracking device, hardware orientation device, or any other such input. The input 420 may be tracking the physical movement of a viewer 830, including, but not limited to, a camera, movement sensor, body tracking device, geospatial tracking device, or any such input. The input may also be the result of cookie data 430, internet activity detecting devices or any other activity monitoring device.

In a preferred embodiment, the input 420 is an interaction within the second mixed reality environment 1000 which will be described below. However, the input may also be used to change where the viewer 830 is situated in the mixed reality environment 1000. For example, in the case of the football match, the input 420 may change the view of the viewer 830 to mimic the situation where the viewer 830 changes where they are sitting in the second mixed reality environment 1000. This may also be the result of an input 420 or requirement from the provider of the service, provider of the image data, owner or rights holder of the image data, provider of the mixed reality environment service or any other party. This may for instance be the owner of the stadium and so provider of the real-life seats who may decide which seats the viewers 830 using the mixed reality environment may view the mixed reality environment from, based on a payment, subscription or other requirement. The input 420 may also be used to pause or rewind the action etc. The input 420 may also be to control the pupillary distance of the recording, giving a varied sense of in-situation scale, from a ‘god’ view to a ‘human’ view of the live event 710.

The interactions of the viewer 830 within the second mixed reality environment 1000 will be explained through the example of using a virtual reality headset but may also be achieved using any of the inputs listed above, or any other appropriate input method.

The physical movement of a viewer 830 moving their head results in the client-side module moving the view within the second mixed reality environment 1000 by changing the optical representation 810 displayed to the viewer 830. To the viewer 830 this will seem as if they are looking round the second mixed reality environment 1000 in the same way as if they were looking around the real world at the actual live event 710.

The position of the HUD 1040 may be constant relative to the viewer's view, maintaining position while the viewer 830 moves and the optical representation 810 changes.

The optical representation 810 currently presented to the viewer 830, i.e. what is currently in the view of the viewer 830, will include articles or objects, entities or other features. These will have related information about them from the data comprising information relating to the live event 330 or from additional data 440. The information is not necessarily visible in the optical representation, as explained earlier.

The centre of the viewer's view may indicate the viewer's interest 1100. When the viewer interest 1100 interacts with an object, entity or feature, that is, the centre of the view rests on an object, entity or feature of the environment, a portion of the data comprising information relating to the live event 330 may be displayed on the optical representation 810. The interaction may be that the viewer interest 1100 stays solely focussed, i.e. their view is stationary, on a particular object, entity or feature for a particular period of time, or the interaction may be that the viewer interest 1100 rests on a particular object, entity or feature a certain number of times during a particular period of time, although numerous different methods may be adopted to comprise an interaction using the viewer's view. In this way, the subconscious interests of the viewer 830 may be taken into account to provide them with information. For example, this may be used in advertising to present the viewer 830 only with the advertising they are most interested in. For example, when they focus on a particular object that has extra data comprising advertising attached to it, the advertising may appear along with a link to the online retailer. This is especially useful in providing the viewer with an environment that can essentially predict their desires or want for specific information. This may, for example, be used for targeted advertising.

With oral inputs, the interaction may comprise voice commands, and with physical inputs this may comprise specific controls, buttons, command code, track pad or mouse movements etc. The interaction may also be a virtual physical interaction where the viewer 830 picks up a virtual object within the second mixed reality environment 1000.

Optionally, when an article or object, entity or feature are interacted with, the article or object, entity or feature may be animated, transformed or adapted in response to the interaction. As well as potentially adapting the aforementioned display of the information about the event, this may also be in animating the articles for instance, as demonstrated by object 1200 in FIG. 12. For example, the advertising in the form of articles may be animated when interacted with. This makes the advertising stand out and be more attractive to the viewer 830.

Using the previous example of the football match, the interaction may be looking at a particular player for a certain period of time. The player's biography will then appear in the form of a 2D document that can be read. The biography may be presented next to the player, in the corner of the viewer's view or anywhere on the optical representation 810. The biography may include instantly accessible links to the player's social media platforms or other online content. Alternatively, statistics about the player may appear. These may be statistics about the player over the season or in the course of that match. The viewer 830 may set up requirements in the client-side module 400 that decides what information would appear due to what specific inputs or interactions. Football matches often have advertising boards around the sides of the pitch with 2D advertising presented. In the second mixed reality environment 1000 these adverts, when interacted with, may turn into 3D virtual versions of the objects being advertised that the viewer 830 may lift up and interact with physically. The advertising may then further act as links to online retailers or other third-party content. The scoreboards when interacted with may give further match statistics, betting odds and may act as links to betting sites.

The optical representation 810 may also include third-party objects, entities or other features. These may include for example, but are not limited to, virtual or real hardware, software or other application mixing the two, that may be controlled via interactions from the viewer 830. These may be applications, equipment, vehicles, autonomous control systems, automated and/or any HCl driven systems, online stores, social media platforms, betting sites or other websites, databases or online content or any other third-party content.

For instance, the object may be a virtual car that the viewer 830 may drive around the second mixed reality environment 1000. This may also control an actual car in the real live event 710 that the first mixed reality environment 800 and second mixed reality environment 1000 are representing. The object may be a link to a social media account on a third-party's website that the viewer 830 may post on or in other way interact with. The object may be a part of a manufacturing process, for example a remote-controlled robot, and the interaction may control the actual movement of the robot in the live event 710. Although given as examples only, they demonstrate that the interaction and so control over a third-party's object or feature may be virtual and so only within the second mixed reality environment 1000, or a real physical object or feature within the live event 710 that can be remotely controlled by the viewer 830 via interactions within the second mixed reality environment 1000. This not only leads to a truly immersive reality experience with the viewer 830 really being in control of the actions taking place in the live event 710, but also has potential benefits for remote access engineering work for instance. For example, the viewer 830 may take control of robots in disaster zones that would be too dangerous to access safely. The system would not only provide the viewer 830 with visuals of the live event 710 as if they were there in person, but also all the necessary information at their fingertips to make real time, informed decisions, and the ability to interact with and remedy the situation by controlling the robots via remote access. Thus, a safe response to the disaster can be achieved.

The input or interaction may also be in the virtual room, on the HUD 1040. The articles in the HUD 1040, be they 2D images, words or 3D icons or any other article, may act as links to online retailers selling the products etc that were in the advertising of the article, or they may be links to social media streams or news streams etc.

The inputs and interactions are stored for further use. This may be use by the viewer 830 themselves, looking at their use history or be used to better calibrate further interactions etc. The inputs and interaction data may also be passed back to the management module 300 where it may be passed on to the broadcaster for advertising and marketing analysis, in order to better target viewers or other customers with adverts or sales opportunities etc. The information may also be used for service refinement by the service provider, or for any other use. The information may also be passed on to any other third-party.

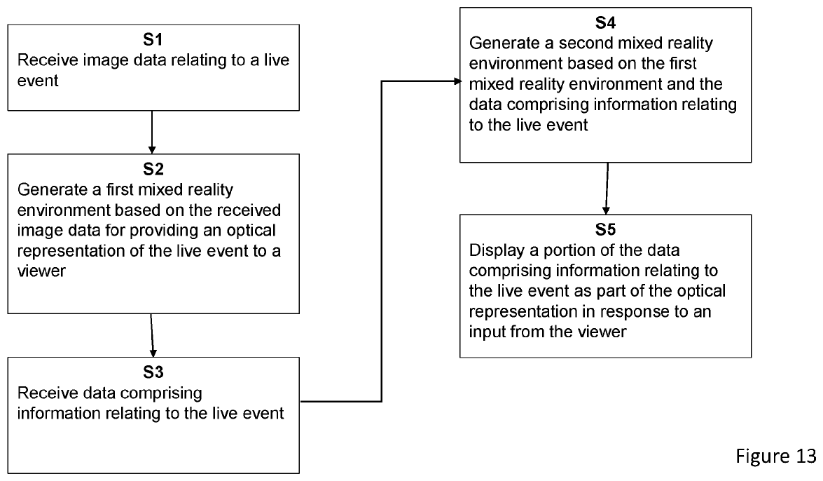

Referring to FIG. 13, there is shown an overview of a method for generating a mixed reality according to a preferred embodiment. The method will be explained below then illustrated through the use of some exemplary embodiments.

At S1, image data 210 relating to a live event 710 is received. This may be received or captured by the capture sub-system 120 and sent to the management sub-system 140, or may be received by the management sub-system 140 or the client-side sub-system 160 from other sources. The image data 210 may be received from a broadcaster, an owner of the image data, an entity running the live event 710 or another entity. The receiving of image data 210 may also comprise the receiving of other data such as telemetry 220, audio 230, geospatial 240 or any other available location specific data. This data may be within the received image data 210, be it embedded in the image data 210, attached to the image data 210 or combined in any other way, or it may be received separately to the image data 210. This data may be received from third parties or the same parties as the providers of the image data 210.

The receiving step S1 may also comprise receiving supplementary audio-visual data 320. This may be received at the management module 300 but may also be received at various other parts of the system. This data may be from the same sources as provided the image data 210, the telemetry 220, audio 230, or geospatial 240 data, or a different source. The supplementary audio-visual data 320 may also be computer-generated data that can be used to augment the image data 210 during the process of generating the first mixed reality environment 800 or the second mixed reality environment 1000.

At S2, a first mixed reality environment 800 is generated based on the received image data 210 for providing an optical representation 810 of the live event 710 to a viewer 830. The first mixed reality environment 800 may also use any of the other data received at step S1. The first mixed reality environment 800 can be generated by the client-side module 400 by defining its own viewer coordinate system based on the viewer 830 and the received image data 210. In particular, the viewer coordinate system may be extrapolated from the telemetry data 220 and GIS/geospatial data 240, any parabolic distortion and the scale of the world in relation to the recording and may use geometric triangulation of the aforementioned data. Once the viewer coordinate system has been generated, the client-side module 400 can accurately map the various sources of image data 210 onto the viewer coordinate system. Optionally, at this stage augmentation may occur in order to ensure that the first mixed reality environment 800 is as accurate as possible. This may be, for example, generating computer imagery to enhance the captured landscape or complete any missing features, sections or objects etc.

Although explained through the use of a method adopting the client-side module 400, any suitable method may be used to generate the first mixed reality environment 800. For example, there are various combinations of processors, software and techniques that may be adopted for generating mixed reality environments.

At S3, data comprising information relating to the live event 330 is received. The data comprising information relating to the live event 330 is extra data comprising any combination of: information about the event; information about objects, entities or other features featuring in the event; and information about incidents occurring in or arising from the event. The data is not derived from the image data 210 itself, although it may be from the same source, or different source. The data comprising information relating to the live event 330 is updated in real time as the information about the event itself changes or is updated.

The data comprising information relating to the live event 330 may be received by the management module 300, but alternatively may also be received by other parts of the system. The data is sent on to the client-side module 400.

S2 and S3 can be performed in any order or concurrently.

At S4, a second mixed reality environment 1000 is generated based on the first mixed reality environment 800 and the data comprising information relating to the live event 330. The second mixed reality environment 1000 may also be based on the other data that has been received at S1 to S3.

The second mixed reality environment 1000 can be generated using the viewer coordinate system and the first mixed reality environment 800. The viewer coordinate system enables the data comprising information relating to the live event 330, any additional data 440 and any articles 1020 (the articles are generated based on the additional data 440 and may for example comprise advertising which may take the form of 3D computer generated objects depicting what is being advertised) to be positioned accurately in the first mixed reality environment 800 in order to generate the second mixed reality environment 1000.

S4 can also comprise rendering the second mixed reality environment 1000.

S4 can be performed sequentially to S2 and S3 or may be performed concurrently with them. In particular, the data comprising information relating to the live event 330 is constantly updated and received by the system and used to update the second mixed reality environment 1000. The second mixed reality environment 1000 may be generated in the same process as generating of the first mixed reality environment 800 that the second mixed reality environment 1000 is based on.

Optionally at S5, a portion of the data comprising information relating to the live event 330 is displayed as part of the optical representation in response to an input 420 from the viewer 830. The input 420 can be in real time, and the display of the information is also in real time.

The input 420 may be any physical input, oral input, tracking of physical movement of a device, tracking of physical movement of a viewer, or any other input. The input 420 may also be an interaction within the second mixed reality environment 1000. When the viewer 830 interacts with an object, entity or other feature in the second mixed reality environment 1000, that has associated data comprising information relating to the live event 710 (that will normally relate to said object, entity or other feature), a portion of that data will be presented in the optical representation 810. This means that the information that was otherwise merely embedded in the second mixed reality environment 1000 and not necessarily visible will appear to the viewer 830 as a result of said interaction. This means that the viewer 830 can enjoy the optical representation 810, uncluttered by information, until they want to know more information about an object. At this point they can interact with the object and be presented with the relevant information.

The interaction may be to control third-party objects, entities or other features, be they solely virtual objects within the second mixed reality environment 1000 or actual objects in the live event 710 that are displayed in the second mixed reality environment 1000.

Examples of use in the entertainment, manufacturing, scientific/explorative, security/military, medical and retail fields shall now be given.

In the example of a football match, the viewer 830 can choose where to sit in the stadium, be it in a virtual front row, rear row, cable cam or whatever position they would like. In each position they would have a 360° view of the action and be able to pause and rewind the action. While watching the live event 710, the viewer 830 would have available to them all the information related to the event. This may be biographies or season or game statistics about individual players or teams, betting odds about specific outcomes in the match, advertising or other information. This information will appear in the optical representation due to a viewer input 420, including interaction and will further, in certain cases, give the viewer 830 the opportunity to place a bet in the case of betting odds, buy the advertised product in the case of advertising, post to social media or interact with the data in other ways.

In the example of a manufacturing line, the viewer 830 may oversee automated production lines with remote augmented views communicating output, power usage, source material levels, or any other data necessary to make informed logistical or economic decisions

In the example of scientific expeditions or field trips, cameras on submersibles, satellites or extra-terrestrial vehicles may provide the scientist with a 360° view of the live event 710 where they can look around in real time with an augmented view of every deployed instrument as an interactable interface. The cameras may take image data outside the visible spectrum. The image data in combination with the interactable element and related information provide the scientists with the ability to make informed decisions within the expedition to best meet the mission's objectives.

In the example of military applications, drones and other remote systems can instantly provide 360° views of an action zone in real time over laid with intelligence data that may provide the ultimate platform for target identification and acquisition. This then enables the viewer 830 to make informed decisions and interact remotely with the drone or other apparatus in the live event from a safe position.

In the example of medical surgery, the system may be used for key hole surgery for example. The surgeon (viewer 830) through paired endoscopic cameras or otherwise, would have an unparalleled view of the surgical area, with vital statistics, case notes, 3-D scans, x-rays, monitoring data and other related data. Data of other similar surgeries, including video tutorials of specific techniques may also be provided. This information provides the surgeon with the ability to make informed decisions and interactions in the real-life event, while being situated remotely.

In retail shops, viewers 830 may view the different items and interact with computer generated versions of them. The system can also register and record where the viewer is looking and so analyse and predict what the client is interested in at that moment. This may be used to predict their desires and refine the service being provided, not only in retail but in any other application. This has huge implications and benefit for the advertising and marketing industries that can test different approached and products to test which is grabbing the prospective customer's attention the most.

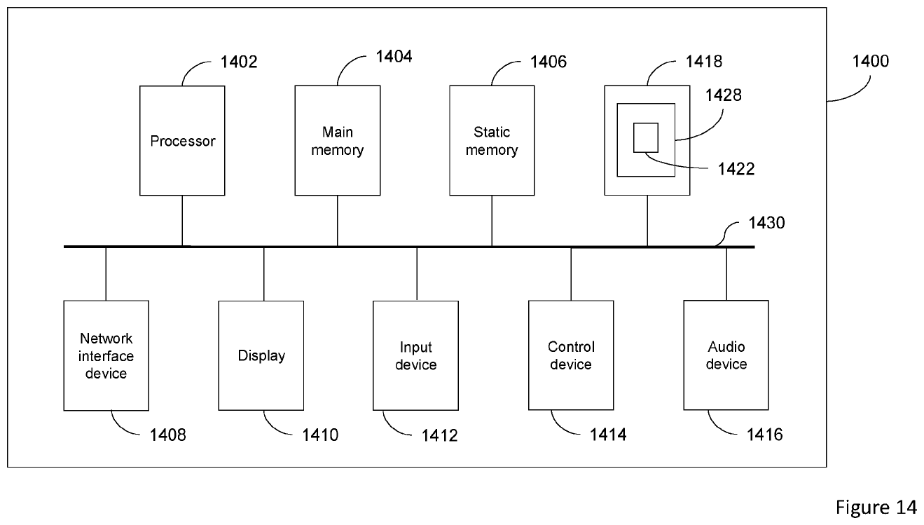

FIG. 14 illustrates a block diagram of one implementation of a computing device 1400 within which a set of instructions, for causing the computing device to perform any one or more of the methodologies discussed herein, may be executed. In alternative implementations, the computing device may be connected (e.g., networked) to other machines in a Local Area Network (LAN), an intranet, an extranet, or the Internet. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single computing device is illustrated, the term “computing device” shall also be taken to include any collection of machines (e.g., computers) that individually or jointly execute a set (or multiple sets) of instructions to perform any one or more of the methodologies discussed herein.

The example computing device 1400 includes a processing device 1402, a main memory 1404 (e.g., read-only memory (ROM), flash memory, dynamic random access memory (DRAM) such as synchronous DRAM (SDRAM) or Rambus DRAM (RDRAM), etc.), a static memory 1406 (e.g., flash memory, static random access memory (SRAM), etc.), and a secondary memory (e.g., a data storage device 1418), which communicate with each other via a bus 1430.

Processing device 1402 represents one or more general-purpose processors such as a microprocessor, central processing unit, or the like. More particularly, the processing device 1402 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 1402 may also be one or more special-purpose processing devices such as an application specific integrated circuit (ASIC), a field programmable gate array (FPGA), a digital signal processor (DSP), network processor, or the like. Processing device 1402 is configured to execute the processing logic (instructions 1422) for performing the operations and steps discussed herein.

The computing device 1400 may further include a network interface device 1408. The computing device 1400 also may include a video display unit 1410 (e.g., a liquid crystal display (LCD) or a cathode ray tube (CRT)), an alphanumeric input device 1412 (e.g., a keyboard or touchscreen), a cursor control device 1414 (e.g., a mouse or touchscreen), and an audio device 1416 (e.g., a speaker).

The data storage device 1418 may include one or more machine-readable storage media (or more specifically one or more non-transitory computer-readable storage media) 1428 on which is stored one or more sets of instructions 1422 embodying any one or more of the methodologies or functions described herein. The instructions 1422 may also reside, completely or at least partially, within the main memory 1404 and/or within the processing device 1402 during execution thereof by the computer system 1400, the main memory 1404 and the processing device 1402 also constituting computer-readable storage media.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid state memory, magnetic tape, a removable computer diskette, a random access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAs, DSPs or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “receiving”, “determining”, “comparing”, “enabling”, “maintaining,” “identifying,” “mapping”, “overlaying”, “rendering”, “producing”, “tracking”, “animating”, “transforming”, “adapting” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is to be understood that the above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A method for generating a mixed reality environment, the method comprising:
receiving image data relating to a live event;
receiving data comprising information relating to the live event; and
generating a mixed reality environment based on the received image data and the data comprising information relating to the live event;
wherein the mixed reality environment comprises an optical representation of the live event to be provided to a viewer; and
the mixed reality environment is configured such that a portion of the data comprising information relating to the live event is displayed as part of the optical representation in response to an input from the viewer.

2. The method of claim 1, wherein generating the mixed reality environment comprises:
generating a first mixed reality environment based on the received image data for providing the optical representation; and
generating a second mixed reality environment based on the first mixed reality environment and the data comprising information relating to the live event.

3. The method of claim 1, wherein receiving the image data comprises capturing the image data.

4. The method of claim 3, wherein capturing the image data comprises capturing a panoramic stereoscopic view from at least one camera array at a respective capture location.

5. The method of claim 4, wherein the optical representation is generated by remapping the image data into a stereoscopic panorama.

6. The method of claim 1, wherein the image data comprises a plurality of views of the live event.

7. The method of claim 1, further comprising receiving telemetry, audio and/or geospatial data relating to the live event.

8. The method of claim 1, wherein the image data is video data.

9. The method of claim 1, wherein the information relating to the live event is at least one of:
information about the event;
information about objects, entities or other features featuring in the event; and
information about incidents occurring in or arising from the event.

10. The method of claim 1, wherein the portion of the data is defined by requirements of at least one of:
the viewer of the image data;
a provider of the image data;
a rights holder of the image data; and
a provider of the mixed reality environment service.

11. The method of claim 1, wherein the data comprising information relating to the live event is updated in real time.

12. The method of claim 1, wherein the optical representation is a view of the live event from a determined position in the mixed reality environment.

13. The method of claim 12, wherein the determined position is determined based on an input from at least one of:
the viewer;
the provider of the image data;
the rights holder in the image data; and
the provider of the mixed reality environment service.

14. The method of claim 12, wherein the view of the live event is a field-of-view view of the live event.

15. The method of claim 1, wherein the optical representation is generated based on at least one of: third-party data, GPS, environment mapping systems, geospatial mapping systems, triangulation systems, and/or viewer inputs.

16. The method of claim 1, wherein generating the mixed reality environment comprises receiving and/or generating additional data and rendering the additional data as articles in and/or around the optical representation.

17. The method of claim 16, wherein the articles are rendered as components of the optical representation, are superimposed over the optical representation and/or form a head-up display.

18. The method of claim 1, wherein the data comprising information relating to the live event is embedded into the mixed reality environment in relation to at least one object in the environment to generate the mixed reality environment.

19-32. (canceled)

33. A system for generating a mixed reality environment, the system comprising:
a processor configured to perform the method of claim 1; and
a display module configured to display the optical representation.

34-38. (canceled)

39. A computer program residing on a non-transitory processor-readable medium and comprising processor-readable instructions configured to cause a processor to perform the method of claim 1.
